(19) United States
(12) Patent Application Publication
(10) Pub. No.: US 2008/0028073 A1
(43) Pub. Date: Jan. 31, 2008

(54) Method, a Device, and a System for Protecting a Server Against Denial of DNS Service Attacks

(75) Inventors: Patrick Trabe, Lannion (FR); Yvon Gourhant, Lannion (FR); Yannick Carlinet, Lannion (FR)

Correspondence Address: OLIFF & BERRIDGE, PLC, P.O. BOX 320850, ALEXANDRIA, VA, 22320-4850, US

(73) Assignee: France Telecom, Paris (FR)

(21) Appl. No.: 11/631,673

(22) PCT Filed: Jul. 8, 2005
(86) PCT No.: PCT/FR05/01777

§ 371 Date: Mar. 14, 2007

(30) Foreign Application Priority Data
Jul. 9, 2004 (FR) 0407705

(51) Int. Cl. G06F 15/173

(52) U.S. Cl. 709/225; 709/238

(57) ABSTRACT

The invention relates to a method of protecting a server (10, 18) against denial of DNS service attacks wherein denial of DNS service attacks targeting the server are detected (100, 102, 104) and data packets addressed to the server are intercepted (110). The transmission of an intercepted data packet to the server is interrupted (116) if the intercepted packet has a transaction number that is not in a list of transaction numbers of requests sent by the server.

The present invention relates to a method, a device, and a system for protecting a server against denial of DNS service attacks.

The invention relates more precisely to a method of this kind wherein:
denial of DNS service attacks targeting the server are detected; and
an intermediate equipment intercepts data addressed to the server.

The domain name system (DNS) supplies an Internet Protocol (IP) address corresponding to a symbolic name such as a URL type address or a domain name. The DNS service is the service provided by the domain name system, which responds to specific requests from client terminals to provide the DNS service.

A DNS service request is therefore a request intended to obtain from the DNS the IP address of a server whose symbolic name is known. It includes a first information field called the “source address” or “identification field” in which the IP address of the sender of the request is written and which is used by the DNS to send a response to the client terminal that sent the request. It also includes a second information field called the “requested address” in which is written the symbolic name of the server whose IP address the sender of the request wishes to obtain.

Clearly the DNS service is indispensable for setting up calls between different terminals connected to each other via an IP type network such as the Internet, because it enables the terminals to locate each other without having to know their respective IP addresses, only their symbolic names. Visiting web sites and sending electronic mail are examples of actions that require use of the DNS service.

The DNS consists of a hierarchical set of DNS servers each of which is associated with a precise subset of the symbolic names managed by the system. In concrete terms, a DNS server includes tables matching the symbolic names that it manages and corresponding IP addresses.

When a client terminal sends a DNS service request to the DNS, because of its hierarchical structure, the DNS can use two different methods to obtain an IP address from a symbolic name.

In a first method, referred to below as the “non-recursive mode” method, a first DNS server receives the request. If it is not competent to respond to it, it sends back to the client terminal a response in which it gives the IP address of a second DNS server able to respond to the request. The client terminal therefore sends its request to the second DNS server which, if it is not competent to respond to it, may give the IP address of a third DNS server. The client terminal repeats its request as many times as necessary to reach the DNS server competent to respond to it.

In a second method, referred to below as the “recursive mode” method, a first DNS server receives the request. If it is not competent to respond to it, it forwards the request to a second DNS server itself. If the second DNS server is not competent to respond to it either, it forwards the request to a third DNS server itself. Recursively, the DNS servers forward the request sent by the client terminal as many times as necessary for it to reach the DNS server competent to respond to it. The response provided by the competent server is then forwarded in the opposite direction until it reaches the first DNS server, which in turn forwards it to the client terminal.

Note that in the recursive mode of processing a DNS service request, a single request sent from the client terminal causes the generation of a plurality of requests forwarded from one DNS server to another.

A denial of DNS service attack consists in generating a fraudulent DNS service request, i.e. a request whose form reproduces the form of DNS service requests but which is not motivated by obtaining a DNS service. There are two prior art methods for generating this kind of fraudulent request.

A first method, known as the “simple attack” method, consists in sending from a client terminal a fraudulent request in which the source address is not that of the client terminal but that of a server that the user of the client terminal wishes to attack.

Thus everything proceeds as if the sender of the request were in fact the attacked server. The DNS will therefore send its response back to the attacked server, whatever its mode of operation (recursive or non-recursive), because it is the IP address of the server that is written into the source address of the request. Note that it is immaterial whether the address requested in the request exists or not. It may entirely crazy.

A second method, known as the “recursive attack” method, consists in sending from a client terminal a fraudulent request in which the requested address is a symbolic name managed by a DNS server that the user of the client terminal wishes to attack.

This type of attack exploits the recursive mode of operation of the DNS system. In fact, although the client terminal sends this request to any of the DNS servers, it will reach the attacked DNS server without further intervention by the client terminal. Note that it is immaterial whether the source address in the request is that of the sender or not. It may be totally crazy, but it may equally well correspond to that of the sender, which does not prevent it from doing harm.

In practice, a malicious user sends a large number of fraudulent DNS service requests from a client terminal so that the attacked server receives a very large number of messages (requests in recursive attacks, responses in simple attacks). This has the effect of rendering the attacked server incapable of providing the service for which it is programmed. Note that simple attacks target all types of servers, whereas recursive attacks target only DNS servers.

A first solution for protecting a server against such denial of DNS service attacks consists in creating access control lists comprehensively defining the client terminals authorized to transmit DNS service requests to specific DNS servers. Accordingly, a request addressed to a DNS server sent from a client terminal that does not appear in the access control list of that DNS server is not processed.

In recursive attacks, the requests may have all the appearances of normal requests, since the source address of the request may actually be the address of the sender and the requested address is not a crazy address. In this situation this solution may be relatively effective. It is very easy to circumvent, however, if an attacker knows at least one IP address of a client terminal authorized to interrogate the DNS server to be attacked. In this situation it suffices to write that IP address into the source address of the fraudulent request.

Similarly, in simple attacks, it suffices for the attacker to know a DNS server that includes in its access control list the IP address of the server to be attacked. A symbolic name managed by that DNS server is then written into the requested address of fraudulent requests.

A second solution, for countering only recursive attacks, is to eliminate this mode of operation of the domain name system. Obviously, this solution has no impact on simple attacks. Moreover, by preventing the domain name system from operating in recursive mode, it penalizes all users of the system for which this mode of operation is eliminated.

Finally, another solution, of a reactive type, for protecting a server against denial of DNS service attacks consists in diverting all requests addressed to an attacked server to another server, usually called a “black hole”, as soon as it has been detected that the server is under attack, so that it is the black hole that receives all the attacks rather than the server itself. The function of the black hole is to receive the data and to destroy it without processing it.

However, that solution does not make the distinction between the kinds of data sent to the attacked server. Moreover, since the server is then no longer capable of providing the service for which it is programmed, the attack may be considered to have succeeded.

The invention aims to improve existing methods of protecting a server against denial of DNS service attacks by providing a method capable of protecting a server against such attacks that enables the data sent to an attacked server to be sorted so that data that is not involved in those attacks can be processed so that the operation of the attacked server is disturbed as little as possible.

The invention therefore consists in a method of protecting a server against denial of DNS service attacks, comprising:
detecting denial of DNS service attacks targeting the server; and
using an intermediate equipment to intercept data packets addressed to the server;

the method being characterized by:
the intermediate equipment analyzing the intercepted data packets; and
for each intercepted data packet, if a criterion determined beforehand by the intermediate equipment is satisfied after the analysis of that data packet, the intermediate equipment interrupting the transmission of that data packet to the server.

Thus requests and/or responses to DNS service requests relating to a server that is under attack are diverted to an intermediate equipment that has its own criteria for sorting data packets addressed to the attacked server. This filtering system, implemented in an intermediate equipment distinct from the attacked server, enables the attacked server to continue to provide the service for which it is programmed without sustaining the harmful effects of the attacks.

A method in accordance with the invention for protecting a server may further include one or more of the following features:
the criterion determined beforehand is linked to the sender of the intercepted packet;
the criterion determined beforehand is linked to an address requested in the intercepted packet if the packet relates to a DNS service request;
the criterion determined beforehand is linked to the absence of a transaction number from the intercepted packet in a list of request transaction numbers sent by the server, that list being kept up to date by the intermediate equipment;
during the step of detecting denial of DNS service attacks:
   abnormal traffic addressed to the server is detected, in particular abnormal traffic using the User Datagram Protocol (UDP);
   a source port number contained in intercepted data packets is extracted; and
   the nature of the protocol used at the level of the application layer in the intercepted data packets is determined;
during the step of detecting denial of DNS service attacks, a destination port number contained in the intercepted data packets is extracted.

The invention also consists in a device for protecting a server against denial of DNS service attacks including means for intercepting data packets addressed to the server, characterized in that it further includes:
means for analyzing the intercepted data packets; and
means for interrupting the transmission to the server of an intercepted data packet if a criterion determined beforehand by the protection device is satisfied following the analysis of that data packet.

Finally, the invention further consists in a system for protecting a server against denial of DNS service attacks including a server liable to be attacked by a client, characterized in that it includes an intermediate equipment formed by a protection device as described above.

A system in accordance with the invention for protecting a server may further have the feature whereby the intermediate equipment is a firewall between the server and an access network providing access from the client to the server.

The invention will be better understood on reading the following description, which is given by way of example only and with reference to the appended drawings, in which:

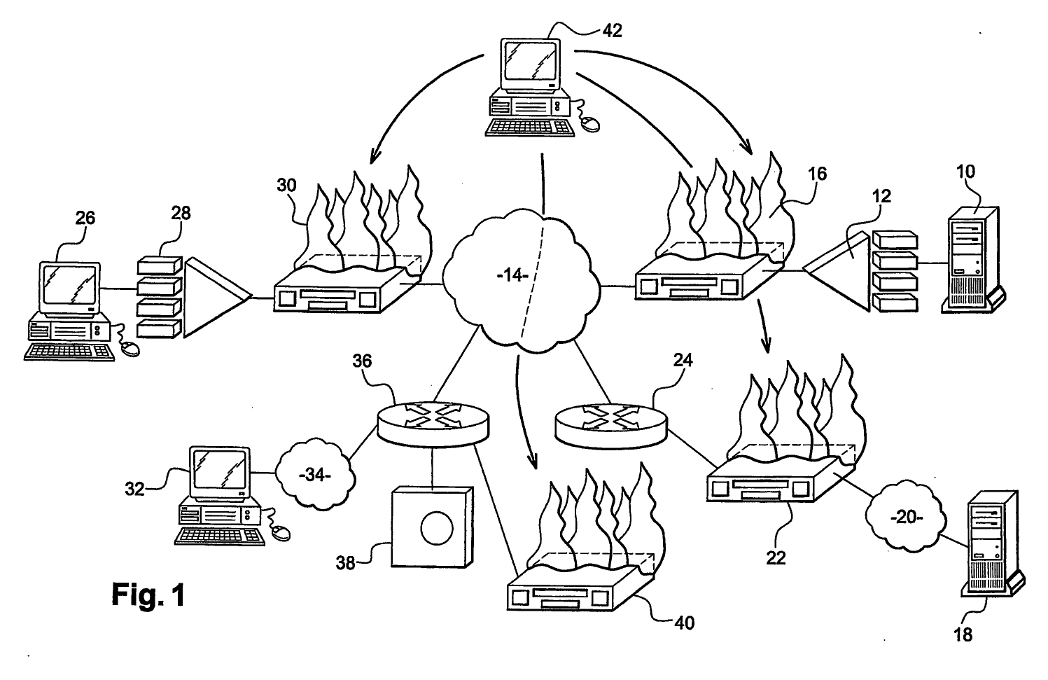

FIG. 1 is a diagram representing the general structure of an installation including a system according to one embodiment of the invention; and

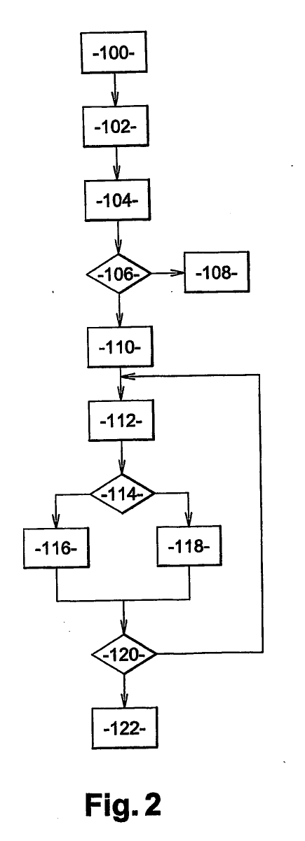

FIG. 2 shows the successive steps of a server protection method according to one embodiment of the invention.

The installation represented in FIG. 1 includes a first server 10 that is adapted to provide a predetermined service to different clients.

For example, this server 10 is a DNS server belonging to a set of servers of the DNS system. Alternatively, the server 10 may be any server adapted to provide any service.

The server 10 is connected to a high bit rate network 12, for example an ADSL network, itself connected to a operator network 14. An intermediate equipment 16 may be disposed at the interface of the operator network 14 and the high bit rate ADSL network. This intermediate equipment 16 is a firewall, for example.

The installation includes a second server 18 also adapted to provide a predetermined service to different clients.

Like the server 10, this server 18 may be a DNS server or any other type of server. It is connected to a private local area network 20 itself connected to the operator network 14. An intermediate equipment 22 and a router 24 may be disposed at the interface of the operator network 14 and the high bit rate network 12. The intermediate equipment 22 is a firewall, for example, like the intermediate equipment 16.

The installation represented in FIG. 1 further includes a first client terminal 26 liable to request the provision of a service by the server 10 or the server 18. This client terminal 26 is connected to a high bit rate network 28, for example identical to the high bit rate network 12, i.e. an ADSL network. This high bit rate network 28 is itself connected to the operator network 14 via an intermediate equipment 30, such as a firewall.

Finally, the installation includes a second client terminal 32 also liable to request the provision of a service by the server 10 or the server 18. It is connected to a packet-switched data transmission network 34 such as the Internet. The Internet network 34 is connected to the operator network 14 via a router 36 connected directly to a control platform 38 and an intermediate equipment 40. The intermediate equipment 40 is a firewall, for example, like the intermediate equipments 16, 22 and 30.

The intermediate equipments 16, 22, 30 and 40 are managed by a conventional system 42 under the control of the operator of the operator network 14.

The method shown in FIG. 2 of protecting a server against denial of DNS service attacks includes a first step 100 of detecting an anomaly.

During the step 100 of detecting an anomaly, one of the elements of the FIG. 1 installation detects abnormal traffic addressed to the server 10 or 18 for example the intermediate equipment 16 for the server 10 or the intermediate equipment 22 (for the server 18).

The traffic linked to DNS service requests and to the corresponding responses is transmitted using the UDP protocol and normally represents less than 10% of the overall traffic of a packet-switched data transmission network. The detection of abnormal traffic may therefore consist in the detection of an abnormal quantity (i.e. a quantity above a predetermined threshold) of UDP packets in transit addressed to the server 10 or 18.

During the subsequent alert step 102, the management system 42 is informed of this anomaly by the intermediate equipment 16 or 22.

Then, during a verification step 104, the intermediate equipment 16 or 22 that has detected the anomaly or the server 10 or 18 that may be under attack analyses the nature of the packets liable to participate in denial of DNS service attacks. The function of this verification step is to determine if the packets actually relate to the provision of a DNS service.

Then, during a test step 106, and in the light of the results of the steps 100 and 104, it is decided whether the server concerned is actually the victim of denial of DNS service attacks. This applies if the number of UDP packets is greater than the predetermined threshold and if those packets actually relate to a DNS service, for example.

Otherwise, the next step is an end-of-process step 108. Otherwise, the next step is a step 110 of protecting the attacked server during which the management system diverts all traffic addressed to the server considered to be under attack to an intermediate equipment of the installation. That intermediate equipment may be the intermediate equipment 16, 22, 30 or 40, as appropriate.

Thereafter, as soon as the intermediate equipment to which data addressed to the server under attack has been diverted receives a data packet addressed to the attacked server, the next step is a step 112 of analyzing the content of that packet. That analysis may indicate a specific transaction number with which that packet is associated, the source address and/or the real sender of the packet, and, where applicable, if the packet relates to a DNS service request, the requested address contained in the request.

The next step is then a test step 114 during which the intermediate equipment, on the basis of information from the analysis step 112, verifies whether a criterion that it has determined beforehand is satisfied. This criterion is described in detail below as a function of various possible attack configurations.

If this packet satisfies the criterion determined beforehand, the next step is a step 116 of interrupting the transmission of that packet to the attacked server. In practice, the packet may be eliminated by the intermediate equipment. Otherwise, the next step is a step 118 of transmitting the packet to the attacked server.

Following the steps 116 and 118, the next step is a test step 120 during which the intermediate equipment verifies whether it has received a new data packet addressed to the attacked server. If so, the next step is the step 112. Otherwise, the next step is an end-of-process step 122.

This method of reacting to denial of DNS service attacks, described above in somewhat general terms, does not necessarily apply in all attack configurations with which the installation may be confronted, and may include certain variations depending on those configurations.

In particular, it is necessary to distinguish simple attack configurations from recursive attack configurations.

Furthermore, it is necessary to distinguish between attack configurations sent from a client terminal connected to the server that it wishes to attack via a data transmission network of which the management system 42 of the operator network 14 has total visibility and attack configurations sent from a client terminal connected to the server that it wishes to attack via a data transmission network of which the management system 42 of the operator network 14 does not have total visibility.

For example, in FIG. 1 the client terminal 26 is connected:
to the server 10 via the high bit rate network 28, the operator network 14, and the high bit rate network 12; and
to the server 18 via the high bit rate network 28, the operator network 14, and the private local area network 20.

It is therefore connected to the servers 10 and 18 via a data transmission network of which the management system 42 has total visibility.

In contrast, the client terminal 32 is connected:
to the server 10 via the Internet 34, the operator network 14, and the high bit rate network 12; and
to the server 18 via the Internet 34, the operator network 14, and the private local area network 20.

It is therefore connected to the servers 10 and 18 via a data transmission network of which the management system 42 does not have total visibility, because of the Internet 34.

It is therefore possible to distinguish between four denial of DNS service attack configurations:
first configuration: the client terminal is connected to the server via a network of which the management system 42 has total visibility and the denial of DNS service attacks are simple attacks;
second configuration: the client terminal is connected to the server via a network of which the management system 42 has total visibility and the denial of DNS service attacks are recursive attacks;
third configuration: the client terminal is connected to the server via a network of which the management system 42 does not have total visibility and the denial of DNS service attacks are simple attacks; and
fourth configuration: the client terminal is connected to the server via a network of which the management system 42 does not have total visibility and the denial of DNS service attacks are recursive attacks.

In the first attack configuration, the method of the invention does not apply because each time a DNS service request is sent the installation is capable of verifying for itself that the source address indicated in the request corresponds to the IP address of its sender. This verification is effected by a broadband access server (BRAS) in the high bit rate network 28 to the data whereof the management system 42 of the operator has access.

In the second attack configuration, the method described above with reference to FIG. 2 is applied.

More precisely, during the step 104 the following are verified for each data packet addressed to the server that may be under attack and intercepted by the intermediate equipment:
the source port number;
the destination port number;
the nature of the protocol used at the level of the application layer.

During the next step 106, if the source port number and the destination port number both have the value 53, which is the value for the port used for the transmission of packets relating to DNS services, and if the protocol used at the level of the application layer is identified as being the DNS protocol, then it is decided that the targeted server is indeed the victim of denial of DNS service attacks. Because the attack configuration is recursive, the packets participating in these attacks relate to fraudulent DNS service requests.

The steps 104 and 106 are executed by the intermediate equipment 16 if the attacked server is the server 10 or by the intermediate equipment 22 if the attacked server is the server 18.

Once again, in this second attack configuration, the intermediate equipment that carried out the verification step 104 and the test step 106 identifies the sender of the fraudulent DNS service requests and where applicable the requested address in those requests and then sends this data to the management system 42. The sender and the requested address are therefore logged by the management system 42.

In such circumstances, the criterion determined beforehand that is used by the intermediate equipment during the test step 114 to interrupt the transmission of a data packet addressed to the attacked server is linked to the identity of the sender of the intercepted packet and where applicable to the requested address that is the subject matter of the request. If the intercepted packet was sent by the sender logged by the management system 42 and, where applicable, if it relates to the requested address logged by the management system 42, the transmission of that data packet is interrupted. Otherwise it reaches its destination.

In the third attack configuration, the method described above with reference to FIG. 2 is applied.

More precisely, during the step 104 the following are verified for each data packet addressed to the server that may be under attack and intercepted by the intermediate equipment:
the source port number;
the nature of the protocol used at the level of the application layer.

During the subsequent test step 106, if the source port number has the value 53 and if the protocol used at the level of the application layer is identified as being the DNS protocol, then it is decided that the targeted server is indeed the victim of denial of DNS service attacks. Since the attack configuration is the simple configuration, the packets participating in these attacks relate to responses to fraudulent DNS service requests.

The steps 104 and 106 are executed by the intermediate equipment 16 if the attacked server is the server 10 or by the intermediate equipment 22 if the attacked server is the server 18.

Once again, in this third attack configuration the intermediate equipment that carried out the verification step 104 and the test step 106 identifies the transaction numbers of each DNS service request sent by the attacked server and sends those transactions numbers to the management system 42, which manages a list of transaction numbers of requests sent by the attacked server.

The transaction numbers from this list correspond to numbers of legitimate requests sent by the attacked server.

The list is stored and kept up to date by the management system or the intermediate equipment.

This list therefore evolves as a function of legitimate requests sent by the server.

In such circumstances, the criterion determined beforehand and used by the intermediate equipment during the test step 114 to interrupt the transmission of a data packet addressed to the attacked server is linked to the transaction number of the intercepted packet. If the intercepted packet has a transaction number that is in the list of transaction numbers managed by the management system 42, it is sent to the attacked server, since it is then a legitimate response to a request issued thereby. Otherwise the transmission of this data packet is interrupted.

In the fourth attack configuration, the method described above with reference to FIG. 2 is applied.

More precisely, during the step 104, the following are verified for each data packet addressed to the server that may be under attack and intercepted by the intermediate equipment:
the source port number;
the nature of the protocol used at the level of the application layer.

During the subsequent test step 106, if the source port number has the value 53 and if the protocol used at the level of the application layer is identified as being the DNS protocol, then it is decided that the targeted server is indeed the victim of denial of DNS service attacks. Since the attack configuration is a recursive configuration, the packets participating in these attacks relate to fraudulent DNS service requests.

The steps 104 and 106 are executed by the intermediate equipment 16 if the attacked server is the server 10 or by the intermediate equipment 22 if the attacked server is the server 18.

Once again, in this fourth attack configuration the intermediate equipment that carried out the verification step 104 and the test step 106 identifies the requested address in the fraudulent requests and then sends this data to the management system 42. This requested address, which is an address managed by the attacked server, is therefore logged by the management system 42.

Under such circumstances, the criterion determined beforehand and used by the intermediate equipment during the test step 114 to interrupt the transmission of a data packet addressed to the attacked server is linked to the requested address forming the subject matter of the request from the intercepted packet. If the intercepted packet relates to the requested address logged by the management system 42, the transmission of that data packet is interrupted. Otherwise it reaches its destination.

It is clear that a protection method as described above effectively protects an attacked server against denial of DNS service attacks without neutralizing it.

1. A method of protecting a server (10, 18) against denial of DNS service attacks, comprising:
detecting (100, 102, 104) denial of DNS service attacks targeting the server; and
intercepting (110) data packets addressed to the server;
the method being characterized by interrupting (116) the transmission of an intercepted data packet to the server if the intercepted packet has a transaction number that is not in a list of transaction numbers of requests sent by the server.

2. A method according to claim 1 of protecting a server (10, 18) wherein during the step (100, 102, 104) of detecting denial of DNS service attacks:
abnormal traffic addressed to the server is detected (100);
a source port number contained in intercepted data packets is extracted (104); and
the nature of the protocol used at the level of the application layer in the intercepted data packets is determined (104).

3. A method according to claim 2 of protecting a server (10, 18) wherein, during the step (100, 102, 104) of detecting denial of DNS service attacks, a destination port number contained in the intercepted data packets is extracted (104).

4. A device (16, 22, 30, 40) for protecting a server (10, 18) against denial of DNS service attacks including means for intercepting data packets addressed to the server, characterized in that it further includes means for interrupting transmission of an intercepted data packet to the server if the intercepted packet has a transaction number that is not in a list of transaction numbers of requests sent by the server.

5. A system for protecting a server (10, 18) against denial of DNS service attacks including a server liable to be attacked by a client (26, 32) and an intermediate equipment (16, 22, 30, 40), characterized in that the intermediate equipment (16, 22, 30, 40) is a protection device according to claim 4.

6. A server protection system according to claim 5, comprising means (42) for managing the list of transaction numbers, the transaction numbers being transmitted by each of the protection devices.

7. A server protection system according to claim 5, wherein the intermediate equipment (16, 22, 30, 40) is a firewall between the server (10, 18) and an access network providing access from the client to the server.

8. A server protection system according to claim 6, wherein the intermediate equipment (16, 22, 30, 40) is a firewall between the server (10, 18) and an access network providing access from the client to the server.
